(19) United States
(12) Patent Application Publication
(10) Pub. No.: US 2024/0135724 A1
(43) Pub. Date: Apr. 25, 2024

(54) METHODS AND SYSTEMS FOR PREDICTING PARKING SPACE VACANCY

(71) Applicant: Valeo Schalter und Sensoren GmbH, Bietigheim-Bissingen (DE)

(72) Inventor: Jagdish Bhanushali, Auburn Hills, MI (US)

(73) Assignee: Valeo Schalter und Sensoren GmbH, Bietigheim-Bissingen (DE)

(21) Appl. No.: 18/048,694

(22) Filed: Oct. 20, 2022

(51) Int. Cl. G06V 20/58; G06V 10/26; G06V 10/44; G06V 10/82; G06V 40/10; G06V 40/20

(52) U.S. Cl. CPC G06V 20/586; G06V 10/26; G06V 10/44; G06V 10/82; G06V 40/10; G06V 40/25

(57) ABSTRACT

A system for available parking space prediction within a parking area is provided. The system includes a vehicle-mounted image capture device configured to obtain an image of an object in or in proximity to a parking space within the parking area, the object including one or more of a component of a parked vehicle and a pedestrian in proximity to the parked vehicle. The system further includes a processor and a non-transitory memory storing instructions. The instructions cause the processor to receive the image from the image capture device, determine a characteristic of one or more of the component and the pedestrian in the image, and predict, using a machine learning algorithm and based on the characteristic, a probability that the parked vehicle will vacate the parking space within a predetermined period of time.

### BACKGROUND

One of the many issues in certain highly populated and/or trafficked areas is finding a parking space in which to leave a vehicle. Due to a scarcity of parking spaces and an increase in the number of vehicles seeking parking spaces, an operator of a vehicle can waste time and resources (e.g., fuel) trying to find a vacant parking space.

Existing parking guidance systems often adopt fixed sensors or cameras surveying a particular parking area and attempt to identify spots that are presently vacant in order to notify operators seeking a parking space.

Other existing systems utilize dashboard cameras or other vehicle equipment to identify a vacant parking space as a vehicle approaches the vacant parking space. However, while these systems may aid in more rapidly identifying the vacant parking spaces, the systems provide no guidance as to future availability of one or more parking spaces in a parking area.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein relate to improvements to parking space vacancy prediction and detection, which may aid in saving vehicle operators time, but may also reduce emissions and other detrimental effects associated with motor vehicle operation. Therefore, the present inventor has developed a system providing improved parking spot vacancy detection and prediction.

According to embodiments of the present disclosure, a system for available parking space prediction within a parking area is provided. The system includes a vehicle-mounted image capture device configured to obtain an image of an object in or in proximity to a parking space within the parking area, wherein the object comprises one or more of a component of a parked vehicle and a pedestrian in proximity to the parked vehicle, a processor, and a non-transitory memory storing instructions that when executed by the processor cause the processor to perform operations including receiving the image from the image capture device, determining a characteristic of one or more of the component and the pedestrian in the image, and predicting, by a machine learning algorithm and based on the characteristic, a probability that the parked vehicle will vacate the parking space within a predetermined period of time.

The component may correspond to one of a door, a trunk lid, a hood, and a hatch.

The characteristic of the component may correspond to currently open or currently closed.

The machine learning algorithm may include a convolutional neural network.

The determining may include performing image segmentation on the image and determining one or more contours of the object based at least in part on output from a recurrent neural network with a convolutional neural network.

The convolutional neural network may be configured to determine the characteristic based on the one or more contours.

The characteristic may include one or more of a posture of the pedestrian and a trajectory of the pedestrian toward the parked vehicle.

The characteristic may include a distance between the pedestrian and the parked vehicle, and a trajectory of the pedestrian.

The image capture device may include a plurality of vehicle mounted cameras.

According to further embodiments of the present disclosure, a method for available parking space prediction within a parking area, is provided. The method includes receiving an image, from a vehicle mounted image capture device, of an object in or in proximity to a parking space within the parking area, wherein the object comprises one or more of a component of a parked vehicle and a pedestrian in proximity to the parked vehicle, determining a characteristic of one or more of the component and the pedestrian in the image, and predicting, by a machine learning algorithm and based on the characteristic, a probability that the parked vehicle will vacate the parking space within a predetermined period of time.

The component may correspond to one of a door, a trunk lid, a hood, and a hatch.

The characteristic of the component may correspond to one of currently open or currently closed.

The machine learning algorithm may include a convolutional neural network.

The determining may include performing image segmentation on the image and determining one or more contours of the object based at least in part on output from a recurrent neural network with a convolutional neural network.

The convolutional neural network may be configured to determine the characteristic based on the one or more contours.

The characteristic may include one or more of a posture of the pedestrian and a trajectory of the pedestrian toward the parked vehicle.

The characteristic may include a distance between the pedestrian and the parked vehicle, and a trajectory of the pedestrian.

According to still further embodiments, a non-transitory computer-readable media storing instructions that when executed by a processor, cause the processor to perform operations, is provided. The operations include receiving an image, from a vehicle mounted image capture device, of an object in or in proximity to a parking space within the parking area, wherein the object comprises one or more of a component of a parked vehicle and a pedestrian in proximity to the parked vehicle, determining a characteristic of one or more of the component and the pedestrian in the image, and predicting, by a machine learning algorithm and based on the characteristic and an associated status, a probability that the parked vehicle will vacate the parking space within a predetermined period of time

The component may correspond to one of a door, a trunk lid, a hood, and a hatch.

The characteristic of the component may correspond to currently open or currently closed.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1A shows an example parking area with one or more parking space vacancies in accordance with one or more embodiments;

FIG. 1B shows the parking area of FIG. 1A in which a vacant parking space is not currently available, and a prediction as to vacancy may be desirable;

FIGS. 2A-C show an illustrative schematic of a segmentation scheme for identifying one or more components of a vehicle and associated characteristics thereof;

FIG. 3 shows an example of identification of component characteristics according to embodiments of the present disclosure;

FIG. 4 shows a flowchart for determining a vacancy prediction for a parking space in accordance with one or more embodiments of the disclosure;

FIG. 5 shows an illustrative architecture for a neural network configured for vacancy predictions according to embodiments of the present disclosure;

FIG. 6 shows a flowchart for improving confidence in a vacancy prediction based on human feedback in accordance with one or more embodiments of the disclosure;

FIG. 7 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

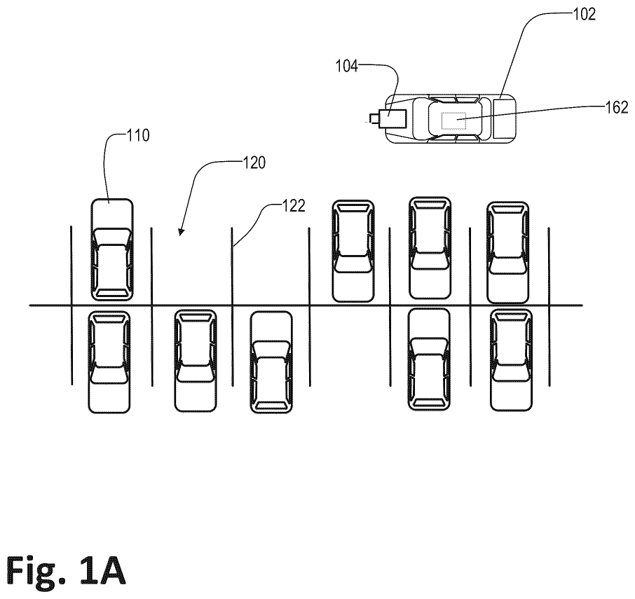

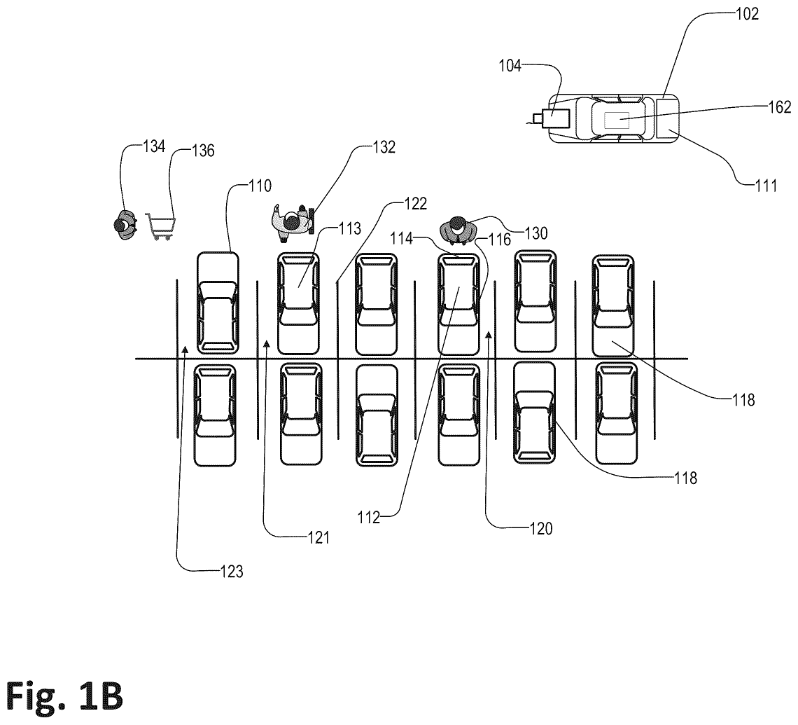

In the following description of FIGS. 1-7, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a parking space” includes reference to one or more of such parking spaces.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Embodiments disclosed herein relate to a system and method for predicting future vacancy of a parking space in a parking area. The method is based on machine learning models and uses image input (e.g., from a vehicle camera) to detect pedestrian presence and component characteristics (also known as “fluents”) related to one or more vehicles in the parking area for determining the probability of vacancy within a predetermine future period of time. Vacancy prediction of a parking space based on pedestrian presence and vehicle fluents is a non-linear determination that may be resolved by machine learning methodologies. Machine learning and artificial intelligence are able to establish complicated non-linear relationships between input data and outcomes.

FIG. 1A shows an example parking area 100 in accordance with one or more embodiments, while FIG. 1B shows the parking area of FIG. 1A in which a vacant parking space is not currently available, and a prediction as to vacancy may be desirable. In general, parking areas may be configured in a myriad of ways. Therefore, parking area 100 is not intended to be limiting with respect to the particular configuration of the parking area (e.g., parking space orientation, parking space line length, etc.) Further, while a general parking area is shown at FIG. 1, the systems and methods described herein may be applied to street parking, parking garage parking, field-based parking, and any other location where vehicles may be parked.

The parking area 100 may include a plurality of parking spaces 120 indicated via one or more markings 122, for example, painted lines. Each parking space 120 may be similarly sized throughout the parking area 100 or different sized parking spaces may be provided. Each parking space may be vacant or may be currently occupied by a vehicle 110, 112. A searching vehicle 102 may progress through the parking area 100 in search of a vacant parking space 120 in which to park the vehicle 102.

Each vehicle 110, 112 includes one or more components such as, for example, a trunk lid 111, a left door 116, a right door 118, a hood 119, a hatch 114, etc. Each of the components of the vehicle 110, 112 may have one or more characteristics such as, for example, open, closed, opening, closing, etc. The components and characteristics discussed herein are illustrative only and not intended as limiting. Additional components (e.g., passenger-side rear door, sunroof, etc.) may also be included on a vehicle and taken into consideration for purposes of carrying out functionality of the present disclosure.

The searching vehicle 102 includes one or more image capture devices 104, such as a manufacturer installed camera, configured to provide images of the area surrounding the vehicle 102. The image capture device 104 may be any suitable device configured to provide an image of an area in proximity to the vehicle. For example, the image capture device 104 may provide a 90 degree field of view (“FOV”), 180 degree FOV, or even 360 degree FOV, and any other suitable FOV, as desired.

The searching vehicle 102 may include one or more output devices configured to provide information to an operator of the vehicle 102. For example, one or more displays installed in the cockpit of the vehicle may be configured to provide information from the processing device 162, e.g., regarding parking spot vacancy and location of a vacancy, to the operator.

The searching vehicle 102 includes one or more processing devices 162 configured to communicate with various systems of the vehicle, e.g., the image capture device 104 and the output device 107. The processing device 162 may receive data (e.g., images) from the image capture device 104 and may process the data to render a vacancy prediction for one or more parking spaces 120, as described in greater detail below.

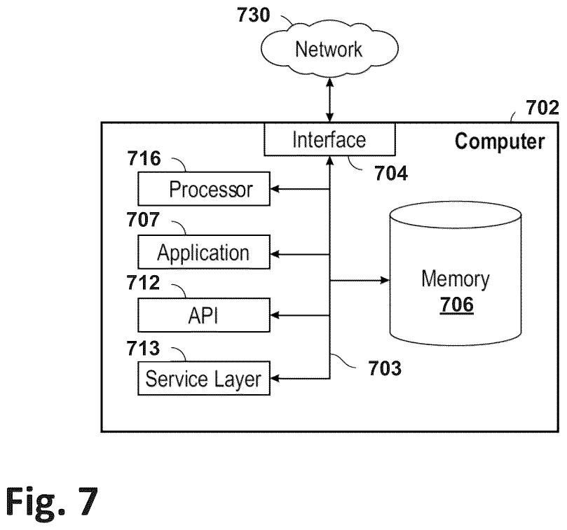

In further embodiments, the processing device 162 may include or may be connected to, wirelessly or wired, a computer processor 705. The computer processor 705 may be part of a remote computer 702 system or may be present within the vehicle 102. The computer processor 705 and the computer 702 system are outlined in further detail in FIG. 7.

The searching vehicle 102 may further include one or more sensors enabling, for example, a determination of position of the vehicle relative to known parking areas 100. For example, a global positioning system (GPS) may be provided in the searching vehicle 102 for providing location information to the processing device 162, thereby enabling the processing device 162 to identify parking areas as well as parking spaces that may be in proximity to the searching vehicle 102.

The searching vehicle 102 according to embodiments of the present disclosure may circulate in a parking area 100 while attempting to identify a vacant parking space 120 in which to park the vehicle 102.

Turning to FIG. 1B, within parking area 100 additional entities may be present, for example, one or more pedestrians 130, 132, 134, shopping carts 136, etc. The image capture device 104 may be configured to capture both the vehicles 110, 112 and their associated components, as well as the additional entities for use in predicting the future availability of a parking space.

Current practices do not permit predictions of upcoming parking space vacancies based on images of areas surrounding a vehicle. As such, systems and methods that can provide such predictions may save time, energy, and have a positive environmental impact.

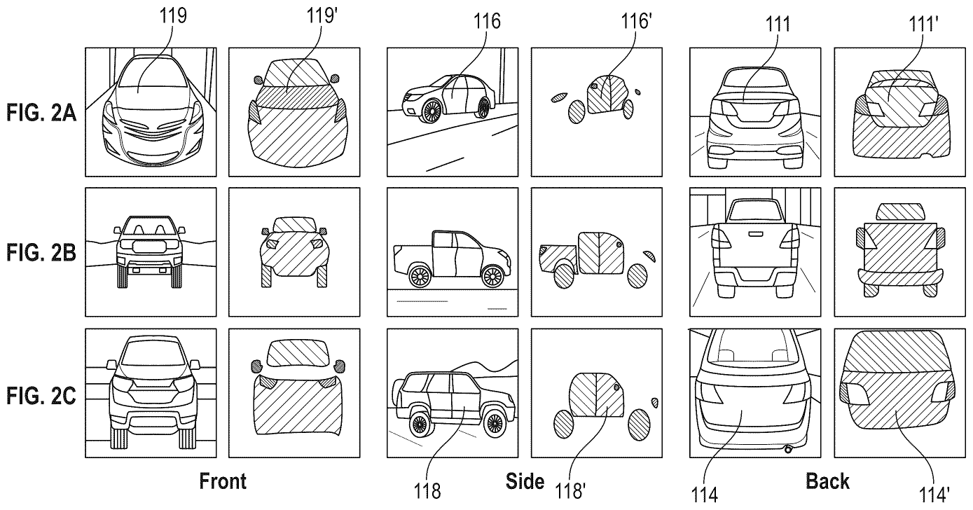

FIGS. 2A-C show an illustrative schematic of a segmentation and classification scheme for identifying (also known as “classifying”) one or more components of a vehicle 110, 112 and associated characteristics thereof. Image segmentation may be performed on one or more images provided by the image capture device 104 for purposes of identifying components of an identified vehicle. In general image segmentation for identifying vehicle components is known in the art. For example, S. Yusuf et al., “Automotive Parts Assessment: Applying Real-time Instance-Segmentation Models to Identify Vehicle Parts,” February 2022, describes identification of car parts using two unique contexts in deep learning. The first is where each part is labelled as a bounding box. However, since a car is a symmetrically complex combination of smaller parts/components, annotating each part with a matching background creates a lower cross-class variability which may lead to a higher level of cross-class mismatches. The second method is to have a pixel-level segmentation of each of the car parts leading to a more accurate, polygonal representation of each of the car parts. This technique is generally more reliable, though the inference time for a semantic or instance segmentation mechanism can be a computationally expensive task.

Real-time object segmentation has gained traction due to improved hardware and methodological improvements in soft computing techniques. In deep-learning, various deep-learning architectures managing framerates of 40+ fps for the instance segmentation. Mask region based convolutional neural networks (RCNN) are frequently used for instance segmentation techniques that comprise a two-stage modelling mechanism involving an object proposal stage extending to a segmentation calculation, mask, class confidence and bounding box offset estimation stages. Hence, the second stage is essentially the calculation of per-instance mask coefficients. The two tasks are run in parallel, and the segmentation process is substantially faster than the other methods.

“You Only Look At CoefficientTs” (YOLACT) is a recent proposed instance segmentation mechanism that has a beneficial trade-off between performance and accuracy by predicting a dictionary of basis masks (category-independent maps) for an image and a set of coefficients that are instance-specific. Instances may play a significant role in car parts segmentation, and YOLACT, SipMask, SipMask++ and Yolact++ paradigms may be implemented for performing the segmentation.

When implementing YOLACT an anchor-based regression may be used to produce the bounding box, class, and coefficients. Further, the Protonet, may be used to produce image sized masks. Both may be combined into a single network to produce a rectified mask along with the bounding box.

With SipMask, single regressor yielding bases mask and bounding box may be fed to the ConvNet for generated spatial coefficient and box classification. the novelty in the spatial preservation module where the coefficients and basis masks divided into a K×K region to preserve and delineate the adjacent objects masks from each other.

The machine learning model for car parts segmentation can be trained on one or more car parts datasets. For example, the training may include normalizing images of the training set to a desired size, partitioning the data set into a training set and a test set, and training to achieve a lowest validation loss calculated based on classification loss, localization loss, and parts segmentation task loss. Cross entropy loss can be used to calculate validation losses with a Stochastic Gradient Descent (SGD) method for parameter optimization with a learning rate of, for example, 0.1 and weight decay of, for example, 0.0015.

Performing segmentation on an image provided by image capture device may enable identification of, for example, a left-side door 116 as shown by the classified left-side door 116′, a right-side door 118 as shown by the classified right-side door 118′, a hood 119 as shown by the classified hood 119′, a hatch 114 as shown by the classified hatch 114′, and a trunk lid 111, as shown by the classified trunk lid 111′, among other things. The identified components of a vehicle described herein are not intended as limiting, and are provided as examples only. Other vehicle components may also be segmented and classified, for example, a vehicle window, a vehicle sunroof, etc.

In addition, similar segmentation and classification techniques may further be used to classify and identify various other entities within the parking area 100. For example, the pedestrians 130, 132, 134 may be identified as pedestrians, while the shopping cart 136 may be identified as a shopping cart. Further examples of recognizable pedestrian actions include, opening/closing a vehicle trunk, opening/closing a vehicle door, entering/exiting a vehicle, handling of a shopping cart (e.g., pushing, emptying, etc.), walking, etc.

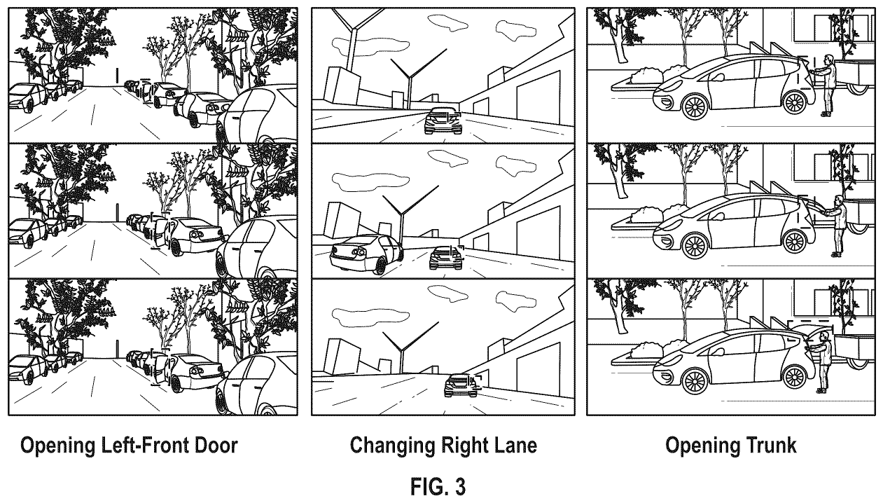

FIG. 3 shows an example of identification of component characteristics as well as pedestrian actions according to embodiments of the present disclosure. The combination of human-car interactions are known in the art as “fluents” and relate to time varying states of the vehicle components when acted upon by humans or other elements (e.g., electro-mechanical actuators.) Fluent detection is rapidly developing and techniques for obtaining fluents continue to progress. For example, B. Li et al., “Recognizing Car Fluents from Video,” 26 Mar. 2016, describes detecting cars with different part statuses and occlusions (e.g., a frontal-view with a hood being open and persons wandering in the front); localizing car parts that have low detectability as individual parts (e.g., an open hood, an open trunk, tail lights, etc.) or that may be occluded by another object; and recognizing time-varying car part statuses where the time-varying nature of these car fluents present certain ambiguities.

A spatial temporal and/or graph (ST-AOG) may be used to represent car fluents at a semantic parts-level. The ST-AOG spans both spatial and temporal dimensions, with representing the whole car, semantic parts, part status from top to bottom, and in time, representing the location and status transitions of the whole car and car parts from left to right. The ST-AOG can output frame-level car bounding boxes, semantic part (e.g, door, light) bounding boxes, part statuses (e.g., open/close, turn on/off), and video-level car fluents (e.g., opening trunk, turning left). Loopy belief propagation (LBP) and dynamic programming (DP) may be implemented in a part-based hidden Markov Model (HMM) in temporal transition for each semantic part. Appearances, deformations, and motion parameters in the model may be trained jointly under the latent structural support-vector machine (SVM) framework.

For semantic part localization, strongly supervised deformable part-based model (SSDPM) may be used. In addition, and-or structures and deep clustering (e.g., DP-DPM) may also be implemented.

By implementing fluent detection techniques, it becomes possible to identify changes in a characteristic of an identified component of a vehicle and/or pedestrian actions. For example, as shown at FIG. 3, a pedestrian opening or closing a left-front door of the vehicle 102 may be detected and characterized as, for example, “pedestrian opening/closing left-side door.” Similarly, a pedestrian opening or closing a trunk of the vehicle may also be identified and characterized as “pedestrian opening/closing trunk lid.” Additional characteristics of the pedestrian and/or the vehicle may also be identified via similar techniques. For example, where the pedestrian has a nearby shopping cart 136 and is loading items from the shopping cart 136 into the trunk or through a door of the vehicle, a classification may be characterized as “pedestrian loading vehicle from shopping cart.”

Pedestrians, 130, 132, 134 may also perform other actions that may be useful as inputs for predicting future vacancy of a parking space, and these actions also may be identified as fluents. For example, a pedestrian may have a trajectory (e.g., running, walking, skipping, etc.) that is toward a vehicle (e.g., with or without a shopping cart 136) or may have a trajectory that indicates moving away from a vehicle. As another example, a pedestrian may be standing or pacing outside a vehicle at a determined distance (e.g., less than 2 meters), and may be operating a handset (e.g., a portable phone) or even conversing on the handset. As yet a further example, a pedestrian may enter or exit a vehicle via a door of the vehicle, e.g., a pedestrian may exit from the left-front door of the vehicle, and in jurisdictions with left-hand drive this may indicated that the vehicle has just been parked.

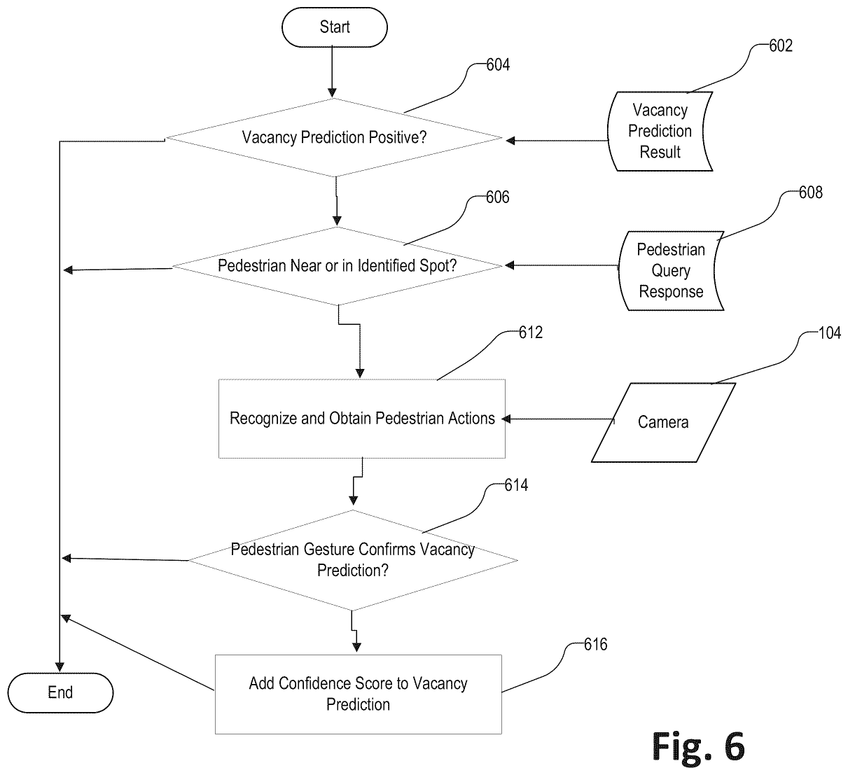

Pedestrians may also perform actions that further aid in determining a status (e.g., potential vacancy) of a parking space. For example, a pedestrian may provide a semiotic or verbal response (e.g., wave, thumbs up, etc.) when asked (e.g., verbally or semiotically) whether they intend to stay in the parking space in which their vehicle is located. In addition, the pedestrian may confirm or deny that the vehicle subject of an inquiry belongs to the pedestrian. Such actions will be discussed in greater detail below with reference to FIG. 6.

The mentioned fluents and characteristics are intended as illustrative only and not as limiting. Any identifiable fluent/characteristic is intended to fall within the scope of the present disclosure.

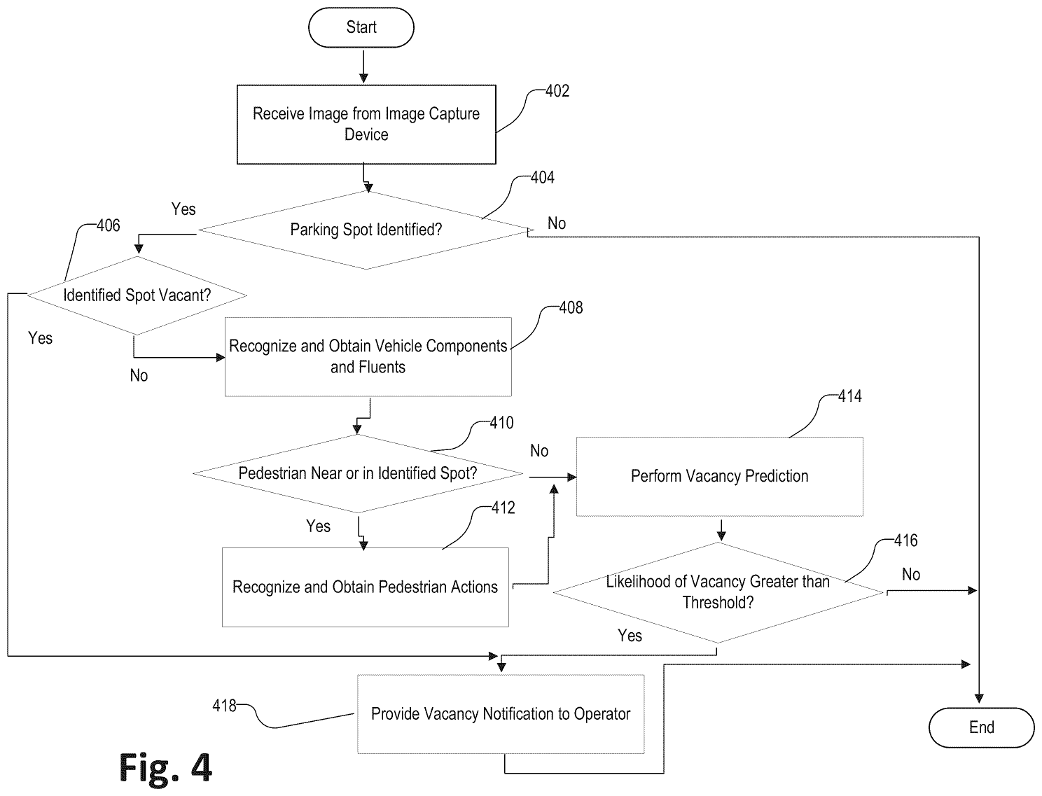

FIG. 4 shows a flowchart for determining a vacancy prediction for a parking space in accordance with one or more embodiments of the disclosure. The steps of FIG. 4 will be described with reference back to FIGS. 1B, 2, and 3 for sake of clarity, and references from these figures will be mentioned without specifically noting in which figure they appear.

According to embodiments of the present disclosure, a searching vehicle 102 may progress through a parking area 100 while the vehicle's image capture device 104 (e.g., an onboard camera) provides one or more images of surroundings of the vehicle 102 to the processing device 162 (step 402). For example, the image capture device 104 may provide a continuous, real-time video feed of 270 degrees of surroundings of the vehicle to the processing device 162. Alternatively, the image capture device 104 may provide one or more still frames at a predetermined interval (e.g., every 10 ms).

The processing device 162 may perform image segmentation and classification to determine whether the image includes a parking space 120 (vacant or occupied) (step 404). For example, the processing device may attempt to identify line markers 122 and/or other characteristics (e.g., lighting posts, etc.) delineating a parking space. Alternatively, or in addition, a parking area diagram may be obtained by the processing device (e.g., from a database or satellite image provider) based on location information from a GPS of the vehicle 102, for purposes of correlating a position of the vehicle 102 relative to one or more known parking spaces 120.

Where no parking space is identified in the image (step 404: no), the processing device 162 stops the process and awaits updated image information from the image capture device 104.

When the processing device 162 identifies a parking space in the image (step 404: yes), the processing devices then determines whether the parking space is vacant or occupied (step 406). For example, the processing device may perform segmentation and classification on the image(s) from the image capture device 104 with a particular focus on the identified parking space 120 to determine whether a vehicle is present therein. When the parking space 120 is determined to be vacant (step 406: yes), the system notifies the operator that there is an available parking space and the location thereof via an output device in the vehicle 102 (step 418).

When the parking space 120 is determined to be occupied (step 406: no), the processing device 162 performs image segmentation and classification to obtain vehicle components and fluents (step 408). For example, the processing device 162 may identify the left side door 116 and hatch 114 of a vehicle 112 occupying the parking space 120. Upon identifying the left side door 116 and hatch 114 of the vehicle 112, the processing device 162 may determine characteristics (i.e., fluents) of these components (e.g, open/closed, opening/closing, etc.) and store this information for input to a prediction process.

The processing device 162 may then determine whether one or more pedestrians 130, 132, 134 are in proximity to the parking space 120 (step 410). For example, as noted above, image segmentation and classification may be undertaken to identify in the image from the image capture device 104 any pedestrians and their proximity to the presently analyzed parking space 120. Where no pedestrian is identified (step 410: no) the processing device 162 passes as inputs the identified vehicle components and characteristics thereof to the vacancy prediction (step 414) that will be described in greater detail below.

When a pedestrian 130, 132, 134 is identified in the image in proximity to the parking space 120 being analyzed (step 410: yes), characteristics of the pedestrian may then be identified (step 412) using, for example, by determining the vehicle fluents via the identification techniques discussed above, and using the vehicle fluents to interpret perceived behavior of the pedestrian(s). For example, as shown at FIG. 1B, the pedestrian 130 can be seen standing near the rear hatch 114 of the vehicle 112 in a parking space 120. Although not shown at FIG. 1B, the pedestrian may be opening or closing the hatch 114, loading items into a rear of the vehicle via the hatch, talking on a mobile phone, etc. By detecting the vehicle fluents (e.g., opening hatch) it may be assumed that the pedestrian is opening the hatch and preparing to load the trunk. Any and all of these fluents may be identified by the processing device 162 and stored for providing as inputs to the vacancy prediction process carried out at step 414.

Similarly, as shown at FIG. 1B, another pedestrian 132 may be in proximity to another vehicle 113 in a different parking space 121. During analysis of the parking space 121 it may be determined that the pedestrian 132 has a trajectory taking the pedestrian away from the parking space 121. This information may be provided as input for the vacancy prediction as desired. Another example shows the pedestrian 134 with a shopping cart 136 approaching the vehicle 110 in the parking space 123. This information may also be provided as input for the prediction. For example, when a pedestrian is identified within a threshold distance of a vehicle (e.g., less than 2 meters) a probability may be determined that the pedestrian is associated with the vehicle 110.

A prediction as to whether the parking space under consideration may become available within a configurable period of time is then performed (step 414) using the inputs obtained for the vehicle component characteristics and any pedestrian inputs that may have been determined. According to embodiments of the disclosure, the prediction is performed by the processing unit 162 using a trained machine learning model with the inputs to the model corresponding to the identified components and respective determined characteristics (e.g., left-front door open/opening, trunk opening/closing, etc.), as well as inputs related to the determined pedestrian characteristics (e.g., pedestrian loading trunk, pedestrian walking away from vehicle, etc.) Additional inputs, such as, for example, an operator configured period of time that is acceptable for waiting for a parking spot to be vacated (e.g. 30 seconds, 1 minute, 2 minutes, etc.) may also be provided as an input.

Machine-learned model types may include, but are not limited to, neural networks, random forests, generalized linear models, Bayesian methods, and stochastic processes (e.g. Gaussian process regression). Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. The selection of hyperparameters surrounding a model is referred to as selecting the model “architecture”. Generally, multiple model types and associated hyperparameters are tested and the model type and hyperparameters that yield the greatest predictive performance on a hold-out set of data is selected.

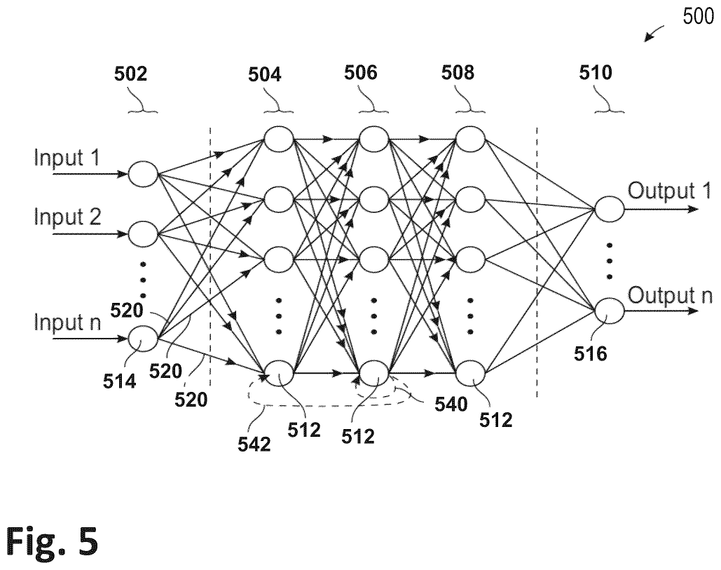

For example, FIG. 5 shows an illustrative architecture for a neural network configured for vacancy predictions according to embodiments of the present disclosure. A neural network 500 uses a series of mathematical functions to make predictions based on observations. A neural network 500 may include an input layer 502, hidden layers, such as a first hidden layer 504, a second hidden layer 506, a third hidden layer 508, and an output layer 510. Each layer represents a vector where each element within each vector is represented by an artificial neuron, such as artificial neurons 512 (hereinafter also “neuron”). A neuron is loosely based on a biological neuron of the human brain. The input layer 502 may receive an observed data vector x where each neuron, such as neuron 514, within the input layer 502 receives one element xᵢ within x. Each element is a value that represents a datum that is observed. The vector x may be called “input data” and, in some embodiments, may be a preprocessed observed geophysical dataset. FIG. 5 displays the input data or vector x as elements x₁, x₂, xᵢ . . . xₙ, where x₁ may be a value that represents a well log sample at a first depth 406, and x₂ may represents a well log sample at a second depth 406, etc.

The output layer 510 may represent the vector y where each neuron, such as neuron 516, within the output layer 510 represents each element yⱼ within y. The vector y may be called “output data.” FIG. 5 displays the output data or vector y with m elements, where an element yⱼ may be a value that represents a probability that a parking space 120, 121, 123 in the image being analyzed may become vacant within a desired time period. For example, y₁ and y₂ may represent a probability of vacancy for parking spaces 120 and 121, respectively. In this embodiment, the neural network 500 may solve a regression problem where all outputs yₘ may depend on a temporal or spatial configuration as determined from the components and characteristics determined as described above.

Neurons in the input layer 502 may be connected to neurons in the first hidden layer 504 through connections, such as connections 520. A connection 520 may be analogous to a synapse of the human brain and may have a weight associated to it. The weights for all connections 520 between the input layer 502 and the first hidden layer 504 make up a first array of weights w, with elements wᵢₖ:

$$w = [ \begin{matrix}{w}_{11} & {w}_{12} & {w}_{1 k} & {w}_{1 L} \\ {w}_{21} & {w}_{22} & {w}_{2 k} & {w}_{2 L} \\ {w}_{i 1} & {w}_{i 2} & {w}_{i k} & {w}_{i L} \\ {w}_{n 1} & {w}_{n 2} & {w}_{n k} & {w}_{n L}\end{matrix} ] , \qquad Equation ( 4 )$$

where k indicates a neuron in the hidden first hidden layer and L is the total number of neurons in the first hidden layer for the embodiment shown in FIG. 5. The elements in each column are the weights associated with the connections 520 between each of the n elements in vector x that propagate to the same neuron k 512 in the first hidden layer 504. The value of a neuron k, aₖ, in the first hidden layer may be computed as

aₖ=gₖ(bₖ+Σᵢxᵢwᵢₖ), Equation (5)

where, in addition to the elements of the input vector x and the first array of weights w, elements from a vector b, which has a length of L, and an activation function gₖ are referenced. The vector b represents a bias vector and its elements may be referred to as biases. In some implementations, the biases may be incorporated into the first array of weights such that Equation (5) may be written as a k=gₖ(Σᵢxᵢwᵢₖ).

Each weight wᵢₖ within the first array of weights may amplify or reduce the significance of each element within vector x. Some activation functions may include the linear function g(x)=x, sigmoid function

$$g ( x ) = \frac{1}{1 + {e}^{- x}} ,$$

and rectified linear unit function g(x)=max(0, x), however, many additional functions are commonly employed. Every neuron in a neural network may have a different associated activation function. Often, as a shorthand, activation functions are described by the function gₖ by which it is composed. That is, an activation function composed of a linear function may simply be referred to as a linear activation function without undue ambiguity.

Similarly, the weights for all connections 520 between the first hidden layer 504 and the second hidden layer 506 make up a second array of weights. The second array of weights will have L rows, one for each neuron in the first hidden layer 504, and a number of columns equal to the number of neurons in the second hidden layer 506. Likewise, a second bias vector and second activation functions may be defined to relate the first hidden layer 504 to the second hidden layer 504. The values of the neurons for the second hidden layer 506 are likewise determined using Equation (5) as before, but with the second array of weights, second bias vector, and second activation functions. Similarly, values of the neurons for the third hidden layer 508 may be likewise determined using Equation (5) as before, but with the third array of weights, third bias vector, and third activation functions. This process of determining the values for a hidden layer based on the values of the neurons of the previous layer and associated array of weights, bias vector, and activation functions is repeated for all layers in the neural network. As stated above, the number of layers in a neural network is a hyperparameter of the neural network 500.

It is noted that FIG. 5 depicts a simple and general neural network 500. In some embodiments, the neural network 500 may contain specialized layers, such as a normalization layer, or additional connection procedures, like concatenation. One skilled in the art will appreciate that these alterations do not exceed the scope of this disclosure. For example, neural network 500 with only connections 520 passing signals forward from the input layer 502 to the first hidden layer 504, from the first hidden layer 504 to the second hidden layer 506 and so forth constitutes a feed-forward neural network. However, in some embodiments a neural network may have any number of connections, such as connection 540, that passes the output of a neuron 514 backward to the input of the same neuron 512, and/or any number of connections 542 that passes the output of the neuron 512 in a hidden layer, such as hidden layer 506 backward to the input of a neuron in a preceding hidden layer, such as hidden layer 504. A neural network with backward-passing connections, such as connection 540 and 542 may be termed a recurrent neural network.

For a neural network 500 to complete a “task” of predicting an output from an input, the neural network 500 must first be trained. Training may be defined as the process of determining the values of all the weights and biases for each weight array and bias vector encompassed by the neural network 500.

To begin training the weights and biases are assigned initial values. These values may be assigned randomly, assigned according to a prescribed distribution, assigned manually, or by some other assignment mechanism. Once the weights and biases have been initialized, the neural network 500 may act as a function, such that it may receive inputs and produce an output. As such, at least one input is propagated through the neural network 500 to produce an output.

Training of the model may be supervised or unsupervised. According to a supervised training plan, a training dataset is composed of labeled inputs and associated target(s), where the target(s) represent the “ground truth”, or the otherwise desired output. That is, the training dataset may be a plurality of input data and a plurality of output data either of which are observed or simulated. The neural network 500 output is compared to the associated input data target(s). The comparison of the neural network 500 output to the target(s) is typically performed by a so-called “loss function”; although other names for this comparison function such as “error function”, “objective function”, “misfit function”, and “cost function” are commonly employed. Many types of loss functions are available, such as the mean-squared-error function, however, the general characteristic of a loss function is that the loss function provides a numerical evaluation of the similarity between the neural network 500 output and the associated target(s). The loss function may also be constructed to impose additional constraints on the values assumed by the weights and biases, for example, by adding a penalty term, which may be physics-based, or a regularization term. Generally, the goal of a training procedure is to alter the weights and biases to promote similarity between the neural network 500 output and associated target(s) over the training dataset. Thus, the loss function is used to guide changes made to the weights and biases, typically through a process called “backpropagation”.

While a full review of the backpropagation process exceeds the scope of this disclosure, a brief summary is provided. Backpropagation consists of computing the gradient of the loss function over the weights and biases. The gradient indicates the direction of change in the weights and biases that results in the greatest change to the loss function. Because the gradient is local to the current weights and biases, the weights and biases are typically updated by a “step” in the direction indicated by the gradient. The step size is often referred to as the “learning rate” and need not remain fixed during the training process. Additionally, the step size and direction may be informed by previously seen weights and biases or previously computed gradients. Such methods for determining the step direction are usually referred to as “momentum” based methods.

Once the weights and biases have been updated, or altered from their initial values, through a backpropagation step, the neural network 500 will likely produce different outputs. Thus, the procedure of propagating at least one input through the neural network 500, comparing the neural network 500 output with the associated target(s) with a loss function, computing the gradient of the loss function with respect to the weights and biases, and updating the weights and biases with a step guided by the gradient, is repeated until a termination criterion is reached. Common termination criteria are: reaching a fixed number of updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the weights and biases are no longer intended to be altered, the neural network 500 is said to be “trained”.

According to embodiments of the present disclosure, ground-truth data for training of the model may include, for example, an annotated video of parking lot with labels assigned to, for example, actions of pedestrians (e.g., pushing cart, opening/closing door/trunk, standing near car). In addition, the annotator providing labels may provide a probability as to whether each labeled parking space will be free within the threshold period (e.g., within the next two minutes) based on the observed actions at a present time t in the video and observed future actions at a time t+n, where n represents a number of time units. In other words, following a review of the entire training video, the annotator knows which parking spaces actually became available, and can label the observed actions from earlier in the video (i.e., at a time t) accordingly. Once the model has been trained, the model may continue to learn and refine itself from future inputs and observations.

Returning to FIG. 4, the neural network 500 may output a prediction as to the likelihood that an analyzed parking space 120 will become vacant within a configurable period of time (e.g., within the next two minutes) (step 414). As noted above, the prediction may indicate probabilities associated with the parking spaces 120, 121, and 123 that the vehicles 112, 113, and 110, respectively, will vacate the parking space within the desired time limit, for example, using a percentage basis (e.g., 30%, 80%, 99%, etc.). According to some embodiments, a probability threshold of 80 percent may be desirable.

The probability outputs are then compared to a threshold value to determine whether the probability is sufficient to indicate to the operator that a parking space will become available (step 416). For example, a threshold probability may be set for 80 percent or greater, and when an output of the model shows a probability greater than 80 percent (step 416: yes), the output device in the vehicle 102 may indicate to the operator that the parking space will likely be available and provide the operator with guidance to the soon-to-be-vacant parking space (step 418). According to the configuration shown at FIG. 1B and the above-described scenario, it may be determined that, for example, based on the pedestrian 130 loading a rear of the vehicle 112 with items, a high probability (>90%) of the vehicle vacating the parking space 120 within a desirable time frame. Similarly, given the approach of the pedestrian 134 to the vehicle 110 with a shopping cart 136, that there is a relatively high probability (>80%) of the parking space 123 becoming availability within a desirable time period. In contrast, with regard to the pedestrian 132 and the trajectory away from the vehicle 113, that there is a low probability (<10%) of parking space 121 becoming available within a desirable time period. These scenarios are intended as illustrative, non-exhaustive, and non-limiting.

Where none of the parking spaces identified are determined to meet the threshold for parking space availability (step 416: no), the vehicle 102 may continue to search the parking area 100 for additional parking spaces that may exhibit higher probability of becoming available.

In addition to the above-mentioned techniques, human feedback may be further implemented in embodiments of the present disclosure to strengthen the training of the model as well as vacancy predictions. FIG. 6 shows a flowchart for improving confidence in a vacancy prediction based on human feedback in accordance with one or more embodiments of the disclosure. A vacancy prediction result 602 determine in accordance with techniques described above may be evaluated to determine whether the parking space is actually free or going to be free (step 606). When it is determined that the prediction was incorrect (step 604: no) the process terminates.

When it is determined that the parking space is indeed available or becoming available (step: 604: yes), the system checks to determine if a pedestrian was identified as present in proximity to the spot (step 606) and if any pedestrian query responses regarding vacancy were received (608). For example, a vehicle may be provided with an external display (e.g., within a grill area of the vehicle, on the windshield, etc.), the external display screen being configured to convey information and/or questions to third parties external to the vehicle. According to such an example, when one or more pedestrians are identified, an operator of a vehicle may provide input related to information to be displayed by the external display such that the information is output to the display. For example, a user may select from a number of prepared questions for display. Alternatively, or in addition, vocal recognition may be implemented to display words of the operator to the external display. The image capture device 104 and/or a microphone (not shown) may the obtain information received, if any, from the pedestrians present.

When no pedestrian is detected with regard to the vacancy prediction under consideration (step 606: no), then the process terminates without updating the vacancy prediction confidence score.

Any detected pedestrian actions may then be analyzed to determine, for example, semiotic hand gestures using the images from the image capture device 104 (step 612). This process may be performed using similar techniques to those described above. For example, a machine learning model may be implemented for purposes of identifying semiotics and information conveyed thereby provided as input to the system.

If hand gestures are detected and the gestures are determined to be a positive indication of pending parking space vacancy (e.g., a hand wave, a thumbs up, a come this way motion, a one minute indication (e.g., index finger pointing upward), etc.) (step 614: yes) then the system increases a confidence score associated with the prediction and may use the confidence score to finalize a future vacancy prediction for a parking space (step 616).

If it is determined that the detected gestures were not helpful or not positive (step 614: no) then the process terminates. For example, where a suspected hand gesture is determined to be related to a closing of a trunk lid (i.e., hand raised then downward motion), then the confidence score is not increased, and the processing terminates.

FIG. 7 shows a computer 702 system in accordance with one or more embodiments. Specifically, FIG. 7 shows a block diagram of a computer 702 system used to provide computational functionalities associated with described algorithms, methods, functions, processes, flows, and procedures as described in the instant disclosure, according to an implementation.

The illustrated computer 702 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device.

Additionally, the computer 702 may include a computer that includes an input device, such as a keypad, keyboard, touch screen, or other device that can accept user information, and an output device that conveys information associated with the operation of the computer 702, including digital data, visual, or audio information 104, 106 (or a combination of information), or a GUI.

The computer 702 can serve in a role as a client, network component, a server, a database or other persistency, or any other component (or a combination of roles) of a computer system for performing the subject matter described in the instant disclosure. The illustrated computer 702 is communicably coupled with a network 730. In some implementations, one or more components of the computer 702 may be configured to operate within environments, including cloud-computing-based, local, global, or other environment (or a combination of environments).

At a high level, the computer 702 is an electronic computing device operable to receive, transmit, process, store, or manage data and information associated with the described subject matter. According to some implementations, the computer 702 may also include or be communicably coupled with an application server, e-mail server, web server, caching server, streaming data server, business intelligence (BI) server, or other server (or a combination of servers).

The computer 702 can receive requests over network 730 from a client application (for example, executing on another computer 702) and responding to the received requests by processing the said requests in an appropriate software application. In addition, requests may also be sent to the computer 702 from internal users (for example, from a command console or by other appropriate access method), external or third-parties, other automated applications, as well as any other appropriate entities, individuals, systems, or computers.

Each of the components of the computer 702 can communicate using a system bus 703. In some implementations, any or all of the components of the computer 702, both hardware or software (or a combination of hardware and software), may interface with each other or the interface 704 (or a combination of both) over the system bus 703 using an application programming interface (API) 712 or a service layer 713 (or a combination of the API 712 and service layer 713.

The API 712 may include specifications for routines, data structures, and object classes. The API 712 may be either computer-language independent or dependent and refer to a complete interface, a single function, or even a set of APIs. The service layer 713 provides software services to the computer 702 or other components (whether or not illustrated) that are communicably coupled to the computer 702.

The functionality of the computer 702 may be accessible for all service consumers using this service layer. Software services, such as those provided by the service layer 713, provide reusable, defined business functionalities through a defined interface. For example, the interface may be software written in JAVA, C++, or other suitable language providing data in extensible markup language (XML) format or other suitable format.

While illustrated as an integrated component of the computer 702, alternative implementations may illustrate the API 712 or the service layer 713 as stand-alone components in relation to other components of the computer 702 or other components (whether or not illustrated) that are communicably coupled to the computer 702. Moreover, any or all parts of the API 712 or the service layer 713 may be implemented as child or sub-modules of another software module, enterprise application, or hardware module without departing from the scope of this disclosure.

The computer 702 includes an interface 704. Although illustrated as a single interface 704 in FIG. 7, two or more interfaces 704 may be used according to particular needs, desires, or particular implementations of the computer 702. The interface 704 is used by the computer 702 for communicating with other systems in a distributed environment that are connected to the network 730.

Generally, the interface 704 includes logic encoded in software or hardware (or a combination of software and hardware) and operable to communicate with the network 730. More specifically, the interface 704 may include software supporting one or more communication protocols associated with communications such that the network 730 or interface's hardware is operable to communicate physical signals within and outside of the illustrated computer 702.

The computer 702 includes at least one computer processor 705. Although illustrated as a single computer processor 705 in FIG. 7, two or more processors may be used according to particular needs, desires, or particular implementations of the computer 702. Generally, the computer processor 705 executes instructions and manipulates data to perform the operations of the computer 702 and any algorithms, methods, functions, processes, flows, and procedures as described in the instant disclosure.

The computer 702 also includes a non-transitory computer 702 readable medium, or a memory 706, that holds data for the computer 702 or other components (or a combination of both) that can be connected to the network 730. For example, memory 706 can be a database storing data consistent with this disclosure. Although illustrated as a single memory 706 in FIG. 7, two or more memories may be used according to particular needs, desires, or particular implementations of the computer 702 and the described functionality. While memory 706 is illustrated as an integral component of the computer 702, in alternative implementations, memory 706 can be external to the computer 702.

The application 707 is an algorithmic software engine providing functionality according to particular needs, desires, or particular implementations of the computer 702, particularly with respect to functionality described in this disclosure. For example, application 707 can serve as one or more components, modules, applications, etc. Further, although illustrated as a single application 707, the application 707 may be implemented as multiple applications 707 on the computer 702. In addition, although illustrated as integral to the computer 702, in alternative implementations, the application 707 can be external to the computer 702.

There may be any number of computers 702 associated with, or external to, a computer system containing computer 702, each computer 702 communicating over network 730. Further, the term “client,” “user,” and other appropriate terminology may be used interchangeably as appropriate without departing from the scope of this disclosure. Moreover, this disclosure contemplates that many users may use one computer 702, or that one user may use multiple computers 702.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for available parking space prediction within a parking area, the system comprising:
a vehicle-mounted image capture device configured to obtain an image of an object in or in proximity to a parking space within the parking area, wherein the object comprises one or more of a component of a parked vehicle and a pedestrian in proximity to the parked vehicle;
a processor;
a non-transitory memory storing instructions that when executed by the processor cause the processor to perform operations comprising:
receiving the image from the image capture device;
determining a characteristic of one or more of the component and the pedestrian in the image; and
predicting, by a machine learning algorithm and based on the characteristic, a probability that the parked vehicle will vacate the parking space within a predetermined period of time.

2. The system of claim 1, wherein the component corresponds to one of a door, a trunk lid, a hood, and a hatch.

3. The system of claim 2, wherein the characteristic of the component corresponds to currently open or currently closed.

4. The system of claim 1, wherein the machine learning algorithm comprises a convolutional neural network.

5. The system of claim 1, wherein the determining comprises performing image segmentation on the image and determining one or more contours of the object based at least in part on output from a recurrent neural network with a convolutional neural network.

6. The system of claim 5, wherein the convolutional neural network is configured to determine the characteristic based on the one or more contours.

7. The system of claim 1, wherein the characteristic comprises one or more of a posture of the pedestrian and a trajectory of the pedestrian toward the parked vehicle.

8. The system of claim 7, wherein the characteristic comprises a distance between the pedestrian and the parked vehicle.

9. The system of claim 8, wherein the image capture device comprises a plurality of vehicle mounted cameras.

10. A method for available parking space prediction within a parking area, the method comprising:
receiving an image, from a vehicle mounted image capture device, of an object in or in proximity to a parking space within the parking area, wherein the object comprises one or more of a component of a parked vehicle and a pedestrian in proximity to the parked vehicle;
determining a characteristic of one or more of the component and the pedestrian in the image; and
predicting, by a machine learning algorithm and based on the characteristic, a probability that the parked vehicle will vacate the parking space within a predetermined period of time.

11. The method of claim 10, wherein the component corresponds to one of a door, a trunk lid, a hood, and a hatch.

12. The method of claim 11, wherein the characteristic of the component corresponds to one of currently open or currently closed.

13. The method of claim 10, wherein the machine learning algorithm comprises a convolutional neural network.

14. The method of claim 10, wherein the determining comprises performing image segmentation on the image and determining one or more contours of the object based at least in part on output from a recurrent neural network with a convolutional neural network.

15. The method of claim 14, wherein the convolutional neural network is configured to determine the characteristic based on the one or more contours.

16. The method of claim 10, wherein the characteristic comprises one or more of a posture of the pedestrian and a trajectory of the pedestrian toward the parked vehicle.

17. The method of claim 16, wherein the characteristic comprises a distance between the pedestrian and the parked vehicle.

18. A non-transitory computer-readable media storing instructions that when executed by a processor, cause the processor to perform operations comprising:
receiving an image, from a vehicle mounted image capture device, of an object in or in proximity to a parking space within the parking area, wherein the object comprises one or more of a component of a parked vehicle and a pedestrian in proximity to the parked vehicle;
determining a characteristic of one or more of the component and the pedestrian in the image; and
predicting, by a machine learning algorithm and based on the characteristic and an associated status, a probability that the parked vehicle will vacate the parking space within a predetermined period of time.

19. The non-transitory computer-readable media of claim 18, wherein the component corresponds to one of a door, a trunk lid, a hood, and a hatch.

20. The non-transitory computer-readable media of claim 19, wherein the characteristic of the component corresponds to currently open or currently closed.
